(19) United States
(12) Patent Application Publication
(10) Pub. No.: US 2025/0254446 A1
(43) Pub. Date: Aug. 7, 2025

(54) IMAGE SENSING DEVICE

(71) Applicant: SK hynix Inc., Icheon-si (KR)

(72) Inventors: Hoon Moo CHOI, Icheon-si (KR); Kyung Do KIM, Icheon-si (KR); Jong Eun KIM, Icheon-si (KR); Hyung June YOON, Icheon-si (KR); Jae Hyung JANG, Icheon-si (KR)

(21) Appl. No.: 19/000,205

(22) Filed: Dec. 23, 2024

(30) Foreign Application Priority Data
Feb. 7, 2024 (KR) 10-2024-0019196

(51) Int. Cl. H04N 25/77

(52) U.S. Cl. CPC H04N 25/77

(57) ABSTRACT

The image sensing device includes a semiconductor substrate; a plurality of unit pixels supported by the semiconductor substrate and arranged in a first direction and a second direction intersecting the first direction to form a pixel array, each unit pixel including a photoelectric conversion element configured to convert light incident to the photoelectric conversion element into photocharges, and a plurality of floating diffusion regions disposed over the photoelectric conversion element to receive and store the photocharges; and a plurality of transfer gates supported by the semiconductor substrate and disposed between adjacent unit pixels, and configured to isolate the adjacent unit pixels from each other and to transfer the photocharges generated by the photoelectric conversion element to the plurality of floating diffusion regions.

### CROSS-REFERENCE TO RELATED APPLICATION

This patent document claims the priority and benefits of Korean patent application No. 10-2024-0019196, filed on Feb. 7, 2024, which is incorporated by reference in its entirety as part of the disclosure of this patent document.

### TECHNICAL FIELD

The technology and implementations disclosed in this patent document generally relate to an image sensing device capable of detecting a distance to a target object.

### BACKGROUND

An image sensing device is a device for capturing optical images by converting light into electrical signals using a photosensitive semiconductor material which reacts to light. With the development of automotive, medical, computer and communication industries, the demand for high-performance image sensing devices is increasing in various fields such as smart phones, digital cameras, game machines, IoT (Internet of Things), robots, security cameras and medical micro cameras.

In order to acquire three-dimensional (3D) images using the image sensing device, information about the distance (or depth) between a target object and the image sensing device is needed.

There have been developments and studies for measuring range and depth (i.e., a distance to a target object) using image sensors. For example, demand for the technologies of measuring range and depth using image sensors have been rapidly increasing in various devices, for example, security devices, medical devices, automobiles, game consoles, virtual reality (VR)/augmented reality (AR) devices, mobile devices, etc. Methods for measuring distance (or depth) information using one or more image sensors are mainly classified into a triangulation method, a Time of Flight (TOF) method, and an interferometry method. Among above-mentioned depth measurement methods, the Time of Flight (TOF) method becomes popular because of its wide range of utilization, high processing speed, and cost advantages.

### SUMMARY

Various embodiments of the disclosed technology relate to an indirect TOF (Time of Flight) image sensing device capable of transmitting photocharges more effectively.

In accordance with an embodiment of the disclosed technology, an image sensing device may include a semiconductor substrate; a plurality of unit pixels supported by the semiconductor substrate and arranged in a first direction and a second direction intersecting the first direction to form a pixel array, each unit pixel including a photoelectric conversion element configured to convert light incident to the photoelectric conversion element into photocharges, and a plurality of floating diffusion regions disposed over the photoelectric conversion element to receive and store the photocharges; and a plurality of transfer gates supported by the semiconductor substrate and disposed between adjacent unit pixels, and configured to isolate the adjacent unit pixels from each other and to transfer the photocharges generated by the photoelectric conversion element to the plurality of floating diffusion regions.

In accordance with another embodiment of the disclosed technology, an image sensing device may include a plurality of unit pixels, each unit pixel including a photoelectric conversion element configured to generate photocharges through photoelectric conversion of incident light and a plurality of floating diffusion regions configured to receive the photocharges and store the received photocharges; and a plurality of transfer gates disposed in a substrate and surrounding each of the plurality of unit pixels and isolating each unit pixel from adjacent unit pixels, and the plurality of transfer gates configured to transfer the photocharges generated by the photoelectric conversion element to the plurality of floating diffusion regions based on a plurality of demodulation control signals having different phases from one another.

It is to be understood that both the foregoing general description and the following detailed description of the disclosed technology are illustrative and explanatory and are intended to provide further explanation of the disclosure as claimed.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a schematic diagram illustrating an example of an image sensing device according to embodiments of the disclosed technology.

FIG. 2 is a plan view illustrating an example structure of a pixel array shown in FIG. 1.

FIG. 3A is a cross-sectional view illustrating an example of the pixel array taken along the line A-A′ shown in FIG. 2 according to an embodiment of the disclosed technology.

FIG. 3B is a cross-sectional view illustrating an example of the pixel array taken along the line B-B′ shown in FIG. 2 according to an embodiment of the disclosed technology.

FIG. 4 is a circuit diagram illustrating an example circuit configuration of pixel transistors formed in each unit pixel.

FIG. 5 is a timing diagram illustrating an example of operations of the image sensing device having the structure of FIG. 2.

FIG. 6 is a plan view illustrating an example structure of a pixel array according to another embodiment of the disclosed technology.

FIG. 7A is a cross-sectional view illustrating an example of the pixel array taken along the line X-X′ shown in FIG. 6.

FIG. 7B is a cross-sectional view illustrating an example of the pixel array taken along the line Y-Y′ shown in FIG. 6.

FIG. 8 is a plan view illustrating an example structure of a pixel array according to another embodiment of the disclosed technology.

FIG. 9A is a timing diagram illustrating an example of operations of the image sensing device having the structure of FIG. 8.

FIG. 9B is a graph illustrating a calculation of a phase difference between modulated light and incident light in the structure of FIG. 8.

FIG. 10 is a plan view illustrating an example structure of a pixel array according to another embodiment of the disclosed technology.

### DETAILED DESCRIPTION

This patent document provides implementations and examples of an image sensing device capable of detecting a distance to a target object that may be used to substantially address one or more technical or engineering issues and mitigate limitations or disadvantages encountered in some other image sensing devices. Some implementations of the disclosed technology suggest examples of an indirect TOF (Time of Flight) image sensing device capable of transmitting photocharges more effectively. In recognition of the issues above, disclosed technology provides various the implementations of the indirect TOF image sensing device capable of more effectively transmitting photocharges generated in a substrate thereof.

Reference will now be made in detail to certain embodiments, examples of which are illustrated in the accompanying drawings. Wherever possible, the same reference numbers will be used throughout the drawings to refer to the same or similar parts. In the following description, a detailed description of related known configurations or functions incorporated herein will be omitted to avoid obscuring the subject matter.

Hereinafter, various embodiments will be described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

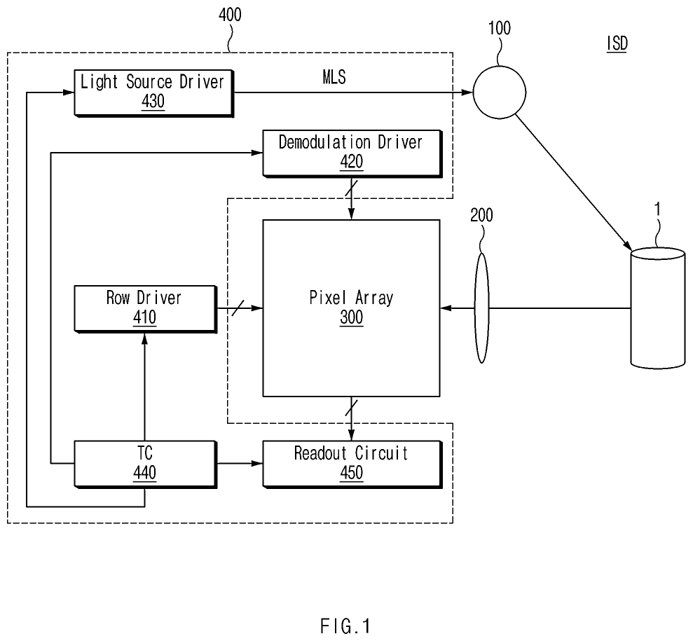

FIG. 1 is a block diagram illustrating an example of an image sensing device ISD based on some implementations of the disclosed technology.

Referring to FIG. 1, the image sensing device ISD may measure the distance to a target object 1 using the Time of Flight (TOF) method. The TOF method may be mainly classified into a direct TOF method and an indirect TOF method. After light has been emitted from a light source to the target object 1, the direct TOF method may measure a time duration in which light is reflected from the target object 1 and returns to the image sensing device ISD, such that the direct TOF method may calculate the distance to the target object 1 using the measured time duration. The indirect TOF method may emit modulated light to the target object 1, may sense light reflected from the target object 1, may calculate a phase difference between the modulated light and the reflected light, and may thus indirectly measure the distance between the image sensing device ISD and the target object 1. Although the image sensing device ISD based on some implementations of the disclosed technology is designed to use the indirect TOF method, the scope or spirit of the disclosed technology is not limited thereto. In addition, the target object 1 does not mean only one independent object, but also may mean a scene captured by the image sensing device ISD.

The image sensing device ISD may include a light source 100, a lens module 200, a pixel array 300, and a control block 400.

The light source 100 may emit light to a target object 1 upon receiving a modulated light signal (MLS) from the control block 400. The light source 100 may be a laser diode (LD) or a light emitting diode (LED) for emitting infrared (IR) light or visible light, or may be any one of a Near Infrared Laser (NIR), a point light source, a monochromatic light source combined with a white lamp or a monochromator, and a combination of other laser sources. Although FIG. 1 shows only one light source 100 for convenience of description, the scope or spirit of the disclosed technology is not limited thereto, and a plurality of light sources may also be arranged in the vicinity of the lens module 200.

The lens module 200 may collect light reflected from the target object 1, and may allow the collected light to be focused onto unit pixels (PXs) of the pixel array 30. For example, the lens module 200 may include a focusing lens having a surface formed of glass or plastic or another cylindrical optical element having a surface formed of glass or plastic. The lens module 200 may include a plurality of lenses that is arranged to be focused upon an optical axis.

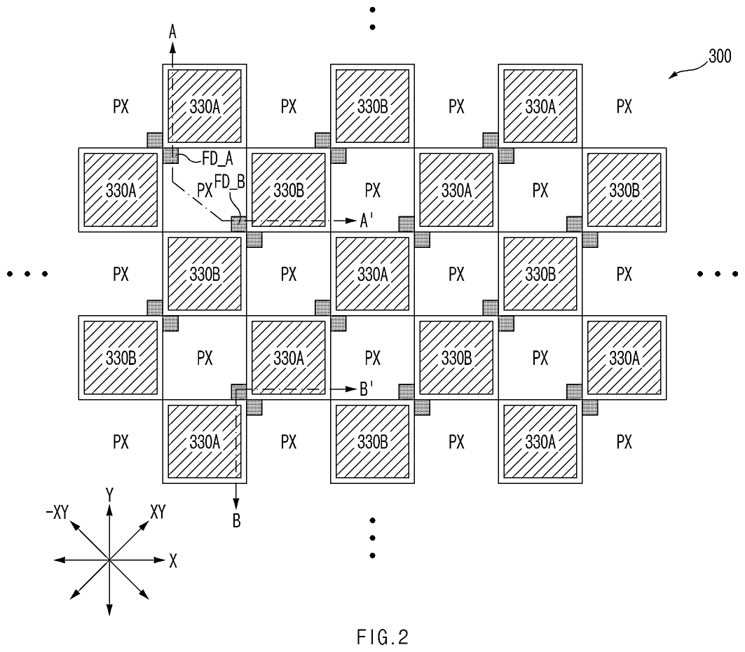

The pixel array 300 may include unit pixels consecutively arranged in a two-dimensional (2D) matrix structure in which unit pixels are arranged in a column direction and a row direction perpendicular to the column direction. The unit pixels may be supported by a semiconductor substrate, e.g., being formed over a semiconductor substrate. Each unit pixel may convert incident light received through the lens module 200 into an electrical signal corresponding to the amount of incident light, and may thus output a pixel signal using the electrical signal. In this case, the pixel signal may be a signal indicating the distance to the target object 1. A photogate may be formed between adjacent unit pixels to transfer photoelectrically converted photocharges to a floating diffusion region. The structure and operations of the pixel array 300 will hereinafter be described with reference to the drawings from FIG. 2.

The control block 400 may emit light to the target object 1 by controlling the light source 100, may process each pixel signal corresponding to light reflected from the target object 1 by driving unit pixels of the pixel array 300, and may measure the distance to the surface of the target object 1 using the processed result.

The control block 400 may include a row driver 410, a demodulation driver 420, a light source driver 430, a timing controller (TC) 440, and a readout circuit 450.

The row driver 410 and the demodulation driver 420 may be generically called a control circuit for convenience of description.

The control circuit may drive unit pixels of the pixel array 300 in response to a timing signal generated from the timing controller 440. The control circuit may generate control signals capable of selecting and controlling at least one row line from among the plurality of row lines. The control signals may include a demodulation control signal for driving transfer gates, a reset signal for controlling a reset transistor, a boosting signal for providing additional electrostatic capacity, a selection signal for controlling a selection transistor, and the like. Although the row driver 410 and the demodulation driver 420 based on some implementations of the disclosed technology are configured independently of each other, the row driver 410 and the demodulation driver 420 based on some other implementations of the disclosed technology may also be implemented as one constituent element.

The light source driver 430 may generate a modulated light signal MLS capable of driving the light source 100 in response to a control signal from the timing controller 440. The modulated light signal MLS may be a signal that is modulated by a predetermined frequency.

The timing controller 440 may generate a timing signal to control the row driver 410, the demodulation driver 420, the light source driver 430, and the readout circuit 450.

The readout circuit 450 may process pixel signals received from the pixel array 300 under control of the timing controller 440, and may thus generate pixel data formed in a digital signal shape. To this end, the readout circuit 450 may include a correlated double sampler (CDS) circuit for performing correlated double sampling (CDS) on the pixel signals generated from the pixel array 300. In addition, the readout circuit 450 may include an analog-to-digital converter (ADC) for converting output signals of the CDS circuit into digital signals. In addition, the readout circuit 450 may include a buffer circuit that temporarily stores pixel data generated from the analog-to-digital converter (ADC) and outputs the pixel data under control of the timing controller 440.

The light source 100 may emit light (i.e., modulated light) modulated by a predetermined frequency to the target objects 1. The image sensing device ISD may sense modulated light (i.e., incident light) reflected from the target objects 1, and may thus generate depth information for each unit pixel (PX). A time delay based on the distance between the image sensing device ISD and each target object 1 may occur between the modulated light and the incident light. The time delay may be denoted by a phase difference between the signal generated by the image sensing device and the modulated light signal MLS controlling the light source 100. An image processor (not shown) may calculate a phase difference generated in the output signal of the image sensing device, and may thus generate a depth image including depth information for each unit pixel (PX).

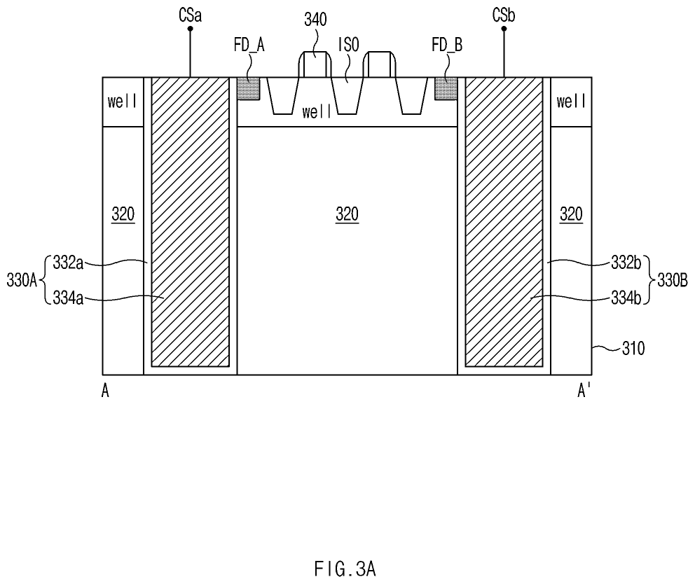

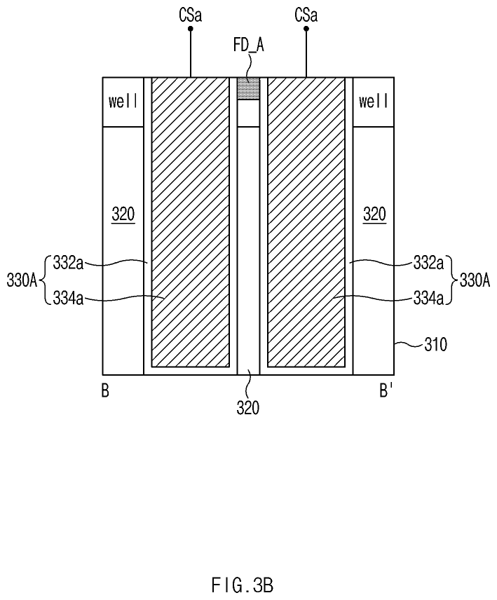

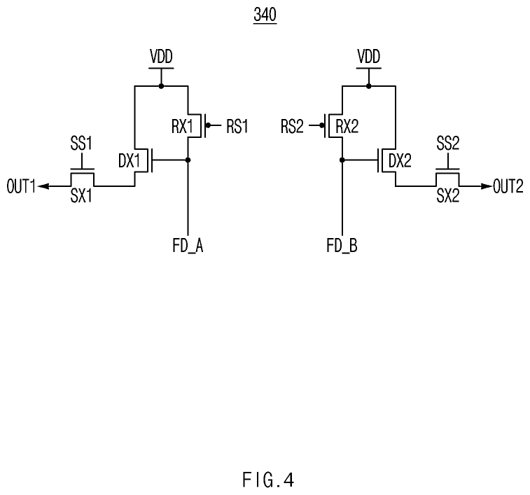

FIG. 2 is a plan view illustrating an example structure of the pixel array shown in FIG. 1. FIG. 3A is a cross-sectional view illustrating an example of the pixel array taken along the line A-A′ shown in FIG. 2 according to an embodiment of the disclosed technology. FIG. 3B is a cross-sectional view illustrating an example of the pixel array taken along the line B-B′ shown in FIG. 2 according to an embodiment of the disclosed technology. FIG. 4 is a circuit diagram illustrating an example circuit configuration of pixel transistors formed in each unit pixel.

Referring to FIGS. 2, 3A, 3B, and 4, the pixel array 300 may include a substrate 310, photoelectric conversion elements 320, transfer gates (330A, 330B), floating diffusion regions (FD_A, FD_B), and pixel transistors 340.

The substrate 310 may include a semiconductor substrate, for example, a P-type semiconductor substrate. The substrate 310 may include a first surface (e.g., a back surface) upon which light is incident, and a second surface (e.g., a front surface) including the pixel transistors 340 formed thereon while facing or opposite to the first surface. In FIGS. 3A and 3B, a bottom surface of the substrate 310 may be the first surface, and a top surface of the substrate 310 may be the second surface.

A P-type well region may be formed from the second surface of the substrate 310 to a predetermined depth, and a device isolation structure (ISO) for isolating the floating diffusion regions (FD_A, FD_B) from the pixel transistors 340 may be formed in the well region. The device isolation structure (ISO) may include a shallow trench isolation (STI) structure in which an insulation material is buried in a trench in which the second surface of the substrate 310 is etched to a predetermined depth.

Photoelectric conversion elements 320 that are supported by the substrate 310 may be formed in the substrate 310 in the illustrated example in FIG. 3A, and may generate and accumulate photocharges through photoelectric conversion of incident light. Each photoelectric conversion element 320 may include N-type impurities. Depending on the embodiment, the photoelectric conversion elements 320 may be formed by stacking a plurality of doped regions. In this case, a lower doped region may be formed by implanting N+-type ions, and an upper doped region may be formed by implanting N⁻-type ions. Each photoelectric conversion element 320 may be arranged to occupy as large a region as possible to increase a fill factor indicating light reception (Rx) efficiency.

One or more photoelectric conversion elements 320 may be formed for each unit pixel (PX). In example devices disclosed herein, one photoelectric conversion element 320 is shown in each unit pixel (PX). In some implementations, as shown in FIG. 2, a region defined by the four transfer gates (330A, 330B) may be one unit pixel (PX) region. In the example shown in FIG. 2, the unit pixel (PX) has four sides on which the transfer gates 330A and 330B are disposed.

The unit pixels (PXs) and the transfer gates (330A, 330B) may be formed alternately in a first direction (e.g., X-axis direction) and a second direction (e.g., Y-axis direction) like chess pieces in a chess board. In the example of FIG. 2, the transfer gate 330A and the transfer gate 330B are arranged on different sides of the unit pixel along the first direction and the second direction. For example, each of the unit pixels (PXs) and the transfer gates (330A, 330B) may have a rectangular shape with the same area (i.e., the same horizontal cross-sectional area) when viewed in a plane. One of the transfer gates (330A, 330B) may be formed between the unit pixels (PXs) adjacent to each other in the first direction and the second direction. In some implementations, the transfer gates (330A, 330B) may be arranged to interleaved with the unit pixels in the first direction and the second direction. For example, along the first direction, if the transfer gate 330A is disposed on the left side of the unit pixel (PX), the transfer gate 330B is disposed on the right side of the unit pixel (PX). Along the second direction, if the transfer gate 330A is disposed on the upper side of the unit pixel (PX), the transfer gate 330B is disposed on the bottom side of the unit pixel (PX).

The transfer gates (330A, 330B) may operate based on a demodulation control signal to alternately transfer or transmit photocharges (electrons) generated by the photoelectric conversion elements 320 to the floating diffusion regions (FD_A, FD_B). For example, for each unit pixel (PX), two transfer gates 330A and two transfer gates 330B may operate alternately, so that the two transfer gates 330A may transfer or transmit photocharges generated by the photoelectric conversion elements 320 to the floating diffusion region FD_A, and the two transfer gates 330B may transfer or transmit photocharges generated by the photoelectric conversion elements 320 to the floating diffusion region FD_B.

In addition to transferring photocharges, the transfer gates (330A, 330B) may be formed and structured to surround each photoelectric conversion element 320 within the substrate 310 to physically isolate the photoelectric conversion elements 320 of adjacent unit pixels (PXs) from each other. As such, each transfer gate is a dual function circuit element for both transferring photocharges as well as providing an isolation or barrier between adjacent unit pixels. For example, each of the transfer gates (330A, 330B) may be formed to have a horizontal cross-section of a rectangular shape, and corner (or edge) regions of transfer gates adjacent to each other in diagonal directions (e.g., XY direction and −XY direction) may be disposed to be in contact with each other, so that each unit pixel (PX) may be formed to be surrounded by the four transfer gates (330A, 330B). In the example of FIG. 2, the four transfer gates including two transfer gates 330A and two transfer gates 330B are disposed to surround the unit pixel (PX).

In some implementations, for each unit pixel (PX), two transfer gates 330A adjacent to each other in the first diagonal direction (e.g., XY direction) may operate together based on a demodulation control signal (CSa) such that photocharges generated by the photoelectric conversion element 320 can be transferred to the floating diffusion region (FD_A). In addition, two transfer gates 330B adjacent to each other in the first diagonal direction while being parallel to the transfer gates 330A may operate together based on the demodulation control signal (CSb) such that photocharges generated by the photoelectric conversion elements 320 can be transferred to the floating diffusion region (FD_B).

Each of the transfer gates (330A, 330B) may be formed in a square pillar shape penetrating the substrate 310. For example, the transfer gate 330A may include a stacked structure in which an insulation material 332a and a conductive material 334a are stacked in a trench etched from the second surface (front surface) of the substrate 310, and the transfer gate 330B may include a stacked structure in which an insulation material 332b and a conductive material 334b are stacked in a trench etched from the second surface (front surface) of the substrate 310. Each of the insulation materials (332a, 332b) may include an oxide layer, and each of the conductive materials (334a, 334b) may include polysilicon doped with conductive impurities.

In this way, the transfer gates (330A, 330B) may extend to a position close to the bottom surface of the substrate 310 and may be formed to surround the photoelectric conversion elements 320, so that photocharges generated from a deep lower region of the photoelectric conversion element 320 can also be transferred to the floating diffusion regions (FD_A, FD_B), thereby preventing such photocharges from going to a floating diffusion region of an adjacent unit pixel and, accordingly, reducing or preventing the undesired crosstalk between the adjacent pixel regions (PXs). Although FIGS. 3A and 3B are cross-sectional views illustrating examples of the transfer gates 330A and 330B formed to penetrate the substrate 310, other implementations are also possible. For example, it should be noted that the transfer gates (330A, 330B) may extend to a position close to the bottom surface of the substrate 310 without penetrating the substrate 310.

As can be seen from FIG. 2, the transfer gates 330A receiving the demodulation control signal (CSa) may be consecutively arranged on a first diagonal line in the first diagonal direction, and the transfer gates 330B receiving the demodulation control signal (CSb) may be consecutively arranged on a second diagonal line in the first diagonal direction, the second diagonal line being parallel to the first diagonal line on which the transfer gates 300A are arranged. In the example, the transfer gates 330A and the transfer gates 330B may be alternately arranged in the second diagonal direction (e.g., −XY direction). For example, the transfer gates 330A and the transfer gates 330B may be alternately arranged on a third diagonal line crossing the first diagonal line and the second diagonal line. The arrangements of the transfer gates 330A and 330B as shown in FIG. 2 are the example only and other implementations are possible. For example, unlike FIG. 2, the transfer gates 330A and 330B may be arranged alternately in the first diagonal direction, the transfer gates 330A may be consecutively arranged on a line along the second diagonal direction, and the transfer gates 330B may be consecutively arranged on another line that is along the second diagonal direction and parallel to the line on which the transfer gates 330A are arranged.

The floating diffusion regions (FD_A, FD_B) may be formed in the upper portion of the substrate 310 to contact the second surface (front surface) of the substrate 310. The floating diffusion regions FD_A may be disposed to contact the transfer gates 330A at corner regions where two surfaces of each unit pixel (PX) meet each other. The floating diffusion regions FD_B may be disposed to contact the transfer gates 330B at corner regions where two surfaces of each unit pixel (PX) meet each other. For example, the floating diffusion regions FD_A and FD_B may be located in two corner regions facing each other from among the four corner regions of the unit pixel (PX). In the example, one floating diffusion region FD_A and one floating diffusion region FD_B may be respectively located in two corner regions facing each other from among the four corner regions of the unit pixel (PX). At this time, the floating diffusion region FD_A may be located in one corner region that is in contact with both transfer gates 330A, and the floating diffusion region FD_B may be located in a corner region that is in contact with both transfer gates 330B.

The floating diffusion regions FD_A adjacent to each other in the second diagonal direction may be isolated from each other by the transfer gates 330A, and the floating diffusion regions FD_B adjacent to each other in the second diagonal direction may be isolated from each other by the transfer gates 330B. The floating diffusion regions (FD_A, FD_B) may be doped with high concentrations of N-type (N+) impurities.

The pixel transistors 340 may include transistors for outputting pixel signals corresponding to photocharges stored in the floating diffusion regions (FD_A, FD_B). For example, the pixel transistors 340 may include reset transistors (RX1, RX2), source follower transistors (DX1, DX2), and selection transistors (SX1, SX2).

Source/drain regions of the reset transistors (RX1, RX2) may be connected to a power-supply voltage (VDD) node and the floating diffusion regions (FD_A, FD_B), and the reset transistors (RX1, RX2) may initialize the floating diffusion regions (FD_A, FD_B) based on a reset signal (RS1, RS2) applied to gate regions thereof. In more detail, the source/drain regions of the reset transistor RX1 may be connected to the power-supply voltage (VDD) node and the floating diffusion region FD_A, and the source/drain regions of the reset transistor RX2 may be connected to the power-supply voltage (VDD) node and the floating diffusion region FD_B. Source/drain regions of the source follower transistors (DX1, DX2) may be connected to the power-supply voltage (VDD) node and the selection transistors (SX1, SX2), and gate regions of the source follower transistors (DX1, DX2) may be connected to the floating diffusion regions (FD_A, FD_B), respectively. In more detail, the source/drain regions of the source follower transistor DX1 may be connected to the power-supply voltage (VDD) node and the selection transistor SX1, and the source/drain regions of the source follower transistor DX2 may be connected to the power-supply voltage (VDD) node and the selection transistor SX2. The source follower transistor DX1 may generate and output a pixel signal corresponding to the magnitude of voltage generated by photocharges accumulated in the floating diffusion region FD_A. The source follower transistor DX2 may generate and output a pixel signal corresponding to the magnitude of voltage generated by photocharges accumulated in the floating diffusion region FD_B. The source/drain regions of the selection transistors (SX1, SX2) may be connected to the source follower transistor (DX) and the output node (OUT), and the selection transistors (SX1, SX2) may output the pixel signals output from the source follower transistors (DX1, DX2) to the output nodes (OUT1, OUT2) based on selection signals (SS1, SS2) applied to gate terminals thereof. In more detail, the selection transistor SX1 may output the pixel signal output from the source follower transistor DX1 to the output node OUT1 based on the selection signal SS1 applied to the gate terminal thereof, and the selection transistor SX2 may output the pixel signal output from the source follower transistor DX2 to the output node OUT1 based on the selection signal SS2 applied to the gate terminal thereof,

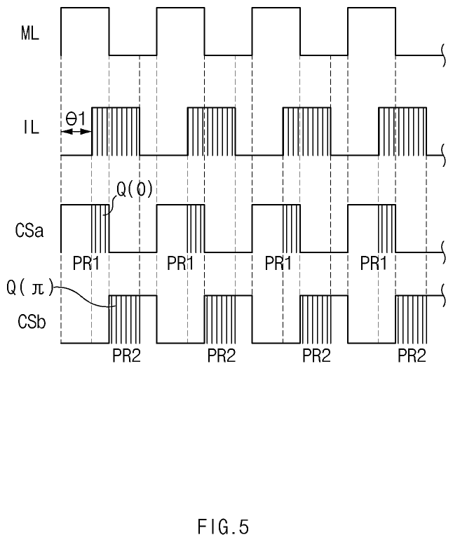

FIG. 5 is a timing diagram illustrating an example of operations of the image sensing device having the structure of FIG. 2.

In more detail, FIG. 5 exemplarily illustrates modulated light (ML), incident light (IL), and first and second demodulation control signals (CSa, CSb).

Referring to FIG. 5, the modulated light (ML) may refer to light that is emitted to the target object 1 by the light source 100 controlled by the control block 400. The modulated light (ML) may be generated to alternately have a high-level section (i.e., a period in which light is emitted) and a low-level section (i.e., a period in which light is not emitted).

The incident light (IL) may refer to light that is incident upon the substrate to generate electron-hole pairs through photoelectric conversion. The incident light (IL) may have a phase difference (θ1) that is changed with the distance between the image sensing device ISD and the target object 1.

The level of each of the modulated light (ML) and the incident light (IL) may refer to the intensity of light.

While electrons generated by the incident light (IL) are captured, each of the first demodulation control signal (CSa) and the second demodulation control signal (CSb) may alternately have a deactivation voltage (L) indicating a low level and an activation voltage (H) indicating a high level. For example, the first demodulation control signal (CSa) may serve as a signal for operating the transfer gates 330A, and may have the same phase as the modulated light (ML). In addition, the second demodulation control signal (CSb) may serve as a signal for operating the transfer gates 330B, and may have a phase difference of 180° (T) with respect to the modulated light (ML). In some implementations, it is assumed that no phase difference occurs between the modulated light signal MLS generating the modulated light (ML) and the modulated light (ML) for convenience of description, such that the modulated light signal MLS and the modulated light (ML) may have the same phase.

In a first period PR1, the first demodulation control signal (CSa) may have the activation voltage (H), and the second demodulation control signal (CSb) may have the deactivation voltage (L). Therefore, electrons generated by incident light (IL) received in the first period PR1 may be captured in the floating diffusion region FD_A by the transfer gates 330A. In this case, the electrons captured in the floating diffusion region FD_A within the first period PR1 may hereinafter be denoted by “Q(0)”.

In a second period PR2, the first demodulation control signal (CSa) may have the deactivation voltage (L), and the second demodulation control signal (CSb) may have the activation voltage (H). Therefore, electrons generated by incident light (IL) received in the second period PR2 may be captured in the floating diffusion region FD_B by the transfer gates 330B. In this case, the electrons captured in the floating diffusion region FD_B within the second period PR2 may hereinafter be denoted by “Q(π)”.

Electrons generated by the incident light (IL) having a phase difference (θ1) that is changed with the distance between the image sensing device ISD and the target object 1 may be captured in the floating diffusion region FD_A by the transfer gates 330A in the first period PR1, and may be captured in the floating diffusion region FD_B by the transfer gates 330B in the second period PR2.

The total charge generated by the incident light (IL) may be defined as the sum of Q(0) and Q(π), and Q(0) and Q(π) may change depending on the phase difference (θ1). As the phase difference (θ1) increases, Q(π) may linearly increase and Q(0) may linearly decrease. Therefore, the phase difference (θ1) can be calculated based on the ratio between Q(0) and Q(π).

For example, the phase difference (θ1) may be calculated as represented by the following equation 1.

$$θ 1 = π \cdot \frac{Q ( π )}{Q ( 0 ) + Q ( π )} \qquad [ Equation 1 ]$$

An image processor (not shown) may calculate the ratio between Q(0) and Q(π) for each unit pixel, may calculate a phase difference (θ1) based on the calculated ratio, and may thus obtain the distance between the image sensing device ISD and the target object 1.

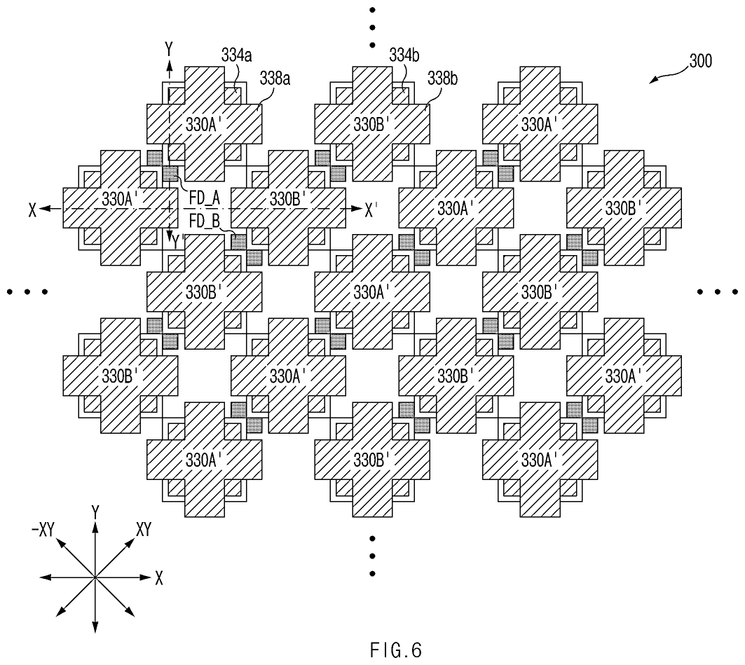

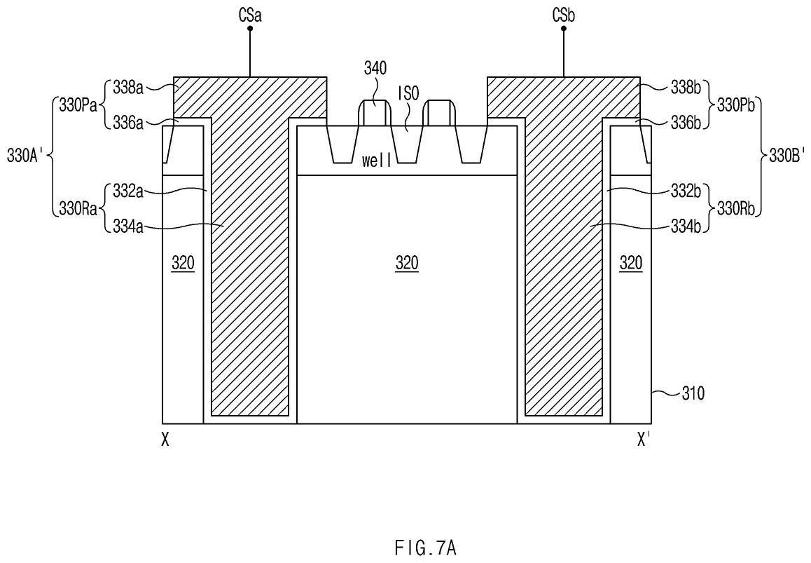

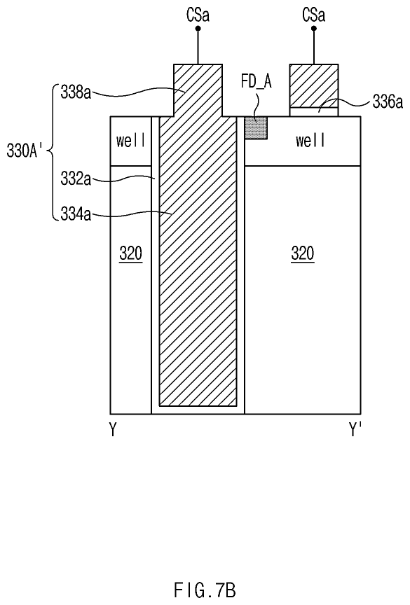

FIG. 6 is a plan view illustrating an example structure of a pixel array according to another embodiment of the disclosed technology. FIG. 7A is a cross-sectional view illustrating an example of the pixel array taken along the line X-X′ shown in FIG. 6. FIG. 7B is a cross-sectional view illustrating an example of the pixel array taken along the line Y-Y′ shown in FIG. 6.

In FIGS. 6, 7A and 7B, the same constituent elements as in FIGS. 2, 3A and 3B are denoted by the same reference numbers, and as such a detailed description thereof will herein be omitted for convenience of description.

Referring to FIGS. 6, 7A, and 7B, in the present embodiment, the constituent elements of the transfer gates (330A′, 330B′) are different in structure from the transfer gates (330A, 330B) shown in FIGS. 2, 3A, and 3B described above.

In the example as shown in FIGS. 6, 7A, and 7B, the transfer gates 330A′ and 330B′ have different shapes from those shown in the example as shown in FIGS. 2, 3A, and 3B. Referring to FIGS. 6, 7A, and 7B, the transfer gate 330A′ may include a recess gate 330Ra and a planar gate 330 Pa, and the transfer gate 330B′ may include a recess gate 330Rb and a planar gate 330Pb.

Each of the recess gates (330Ra, 330Rb) may be formed in a square pillar shape penetrating the substrate 310. The recess gate 330Ra may include a stacked structure in which an insulation material 332a and a conductive material 334a are stacked in a trench etched from the second surface (front surface) of the substrate 310, so that the stacked structure can penetrate the substrate 310. The recess gate 330Rb may include a stacked structure in which an insulation material 332b and a conductive material 334b are stacked in a trench etched from the second surface (front surface) of the substrate 310, so that the stacked structure can penetrate the substrate 310. For example, the recess gates 330Ra and 330Rb may be formed in the same structure as the transfer gates 330A and 330B in FIGS. 2, 3A, and 3B described above. In the example, the recess gates 330Ra and 330Rb may be formed at the same position as the transfer gates 330A and 330B within the pixel array 300.

The planar gates 330 Pa and 330Pb may be connected to the top surfaces of the corresponding recess gates 330Ra and 330Rb, and may partially extend to the pixel regions (PXs). For example, each of the planar gates 330 Pa and 330Pb may be formed in a cross (“+”) shape that extends from the center of the top surface of each of the recess gates 330Ra and 330Rb toward four adjacent pixel regions (PXs), when viewed in a plane. For example, each of the planar gates 330 Pa and 330Pb have portions disposed over the pixel regions (PXs). While each of the recess gate 330Ra and 330Rb are disposed on sides of the photoelectric conversion elements 320 of the corresponding pixel regions (PXs), each of the planar gates 330 Pa and 330Pb have portions disposed over the recess gates 330Ra and 330Rb and another portions disposed over the photoelectric conversion elements 320 of the corresponding pixel regions (PXs). The planar gate 330 Pa may protrude from each surface of the recess gate 330Ra to the pixel region (PX) by a preset length corresponding to the length of the floating diffusion region FD_A, and the planar gate 330Pb may protrude from each surface of the recess gate 330Rb to the pixel region (PX) by a preset length corresponding to the length of the floating diffusion region FD_B.

The planar gate 330 Pa may include an insulation material 336a and a conductive material 338a, and the planar gate 330Pb may include an insulation material 336b and a conductive material 338b. The insulation material 336a may be formed to extend from the insulation material 332a to the top surface of the substrate 310. The insulation material 336b may be formed to extend from the insulation material 332b to the top surface of the substrate 310. Each of the insulation materials 336a and 336b may include an oxide layer. The conductive material 338a may be formed over the insulation material 336a while contacting the top surface of the conductive material 334a of the recess gate 330Ra. The conductive material 338b may be formed over the insulation material 336b while contacting the top surface of the conductive material 334b of the recess gate 330Rb. Each of the conductive materials 338a and 338b may include polysilicon doped with conductive impurities.

As described above, in the transfer gates 330A′ and 330B′, the recess gates 330Ra and 330Rb may be formed to penetrate the substrate 310, and may transfer photocharges generated in the deep lower region of the photoelectric conversion element 320 to the floating diffusion region FD_A and FD_B. In addition, the planar gates 330 Pa and 330Pb may be formed to extend to the top surface of the substrate 310 of the pixel region (PX) to surround the floating diffusion regions FD_A and FD_B, so that a potential is also applied to the top surface of the substrate 310. As a result, photocharges can be more efficiently transferred to the floating diffusion regions FD_A and FD_B.

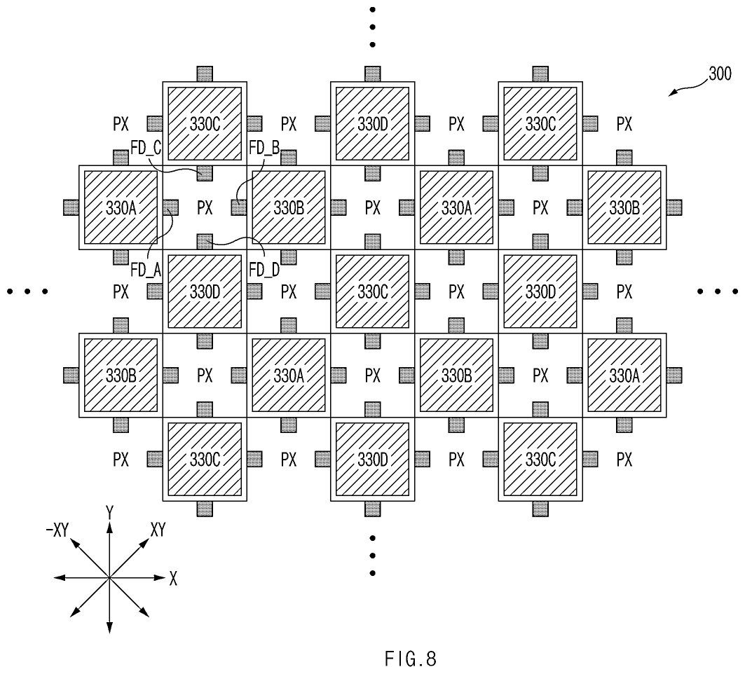

FIG. 8 is a plan view illustrating an example structure of a pixel array according to another embodiment of the disclosed technology.

Compared to the embodiment of FIG. 2 described above, the present embodiment of FIG. 8 is different from the embodiment of FIG. 2 in terms of the floating diffusion regions (FD_A, FD_B, FD_C, FD_D) formed in each unit pixel (PX).

Each unit pixel (PX) may be surrounded by the four transfer gates (330A, 330B, 330C, 330D). The four transfer gates 330A, 330B, 330C, 330D may isolate one unit pixel from other unit pixels. In addition, each unit pixel (PX) may include four floating diffusion regions (FD_A, FD_B, FD_C, FD_D). The transfer gates (330A, 330B, 330C, 330D) may operate individually according to four demodulation control signals having different phases.

The floating diffusion regions (FD_A, FD_B, FD_C, FD_D) may be arranged in one-to-one correspondence with the transfer gates (330A, 330B, 330C, 330D). The floating diffusion regions (FD_A, FD_B, FD_C, FD_D) may be located on each side surface of the unit pixel (PX) while contacting the side surfaces of the transfer gates (330A, 330B, 330C, 330D). The floating diffusion regions (FD_A, FD_B, FD_C, FD_D) may be formed in the upper portion of the semiconductor substrate, as shown in FIGS. 3A and 3B described above. Unlike the example as shown in FIGS. 3A and 3B, the floating diffusion regions (FD_A, FD_B, FD_C, FD_D) may be in contact with central portions of the side surfaces of the corresponding transfer gates (330A, 330B, 330C, 330D) within the upper portion of the semiconductor substrate. In FIG. 8, the remaining components other than the floating diffusion regions (FD_A, FD_B, FD_C, FD_D) may be formed in the same structure as those of FIGS. 2, 3A, and 3B. Therefore, a detailed description of the remaining components other than the floating diffusion regions (FD_A, FD_B, FD_C, FD_D) will herein be omitted for brevity.

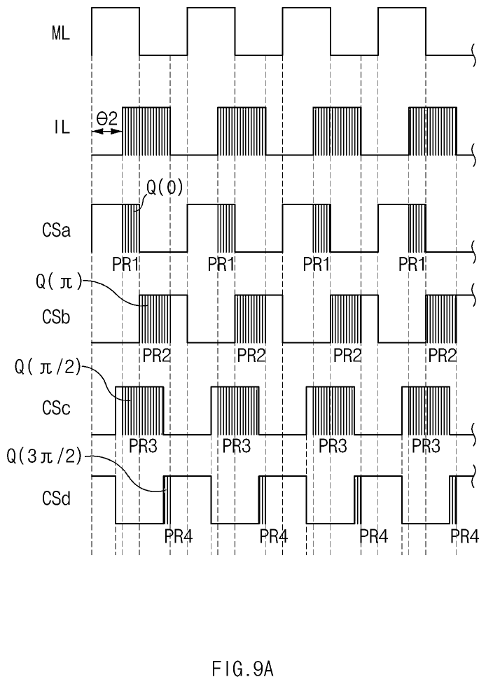

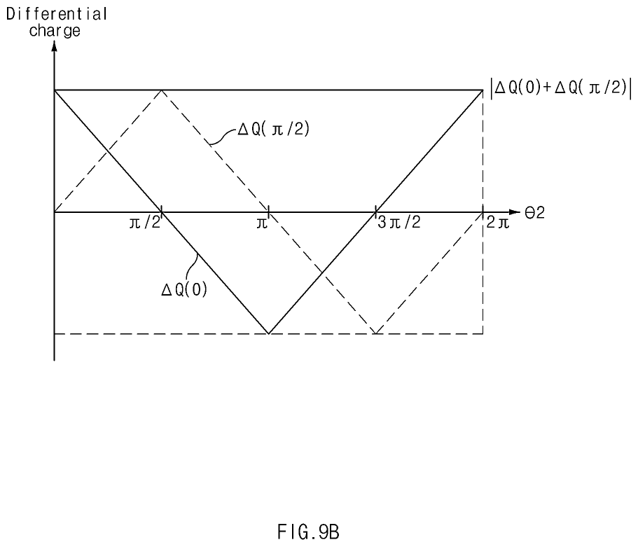

FIG. 9A is a timing diagram illustrating an example of operations of the image sensing device having the structure of FIG. 8. FIG. 9B is a graph illustrating a calculation of a phase difference between modulated light and incident light in the structure of FIG. 8.

Referring to FIG. 9A, modulated light (ML), incident light (IL), and demodulation control signals (CSa, CSb, CSc, CSd) are illustrated. The modulated light (ML) and the incident light (IL) shown in FIG. 9A are substantially the same as those described in FIG. 5, and as such a detailed description thereof will herein be omitted for convenience of description.

The incident light (IL) may have a phase difference (θ2) that is changed with the distance between the image sensing device ISD and the target object 1.

While electrons generated by the incident light (IL) are captured, the demodulation control signals (CSa, CSb, CSc, CSd) may alternately have a deactivation voltage (L) indicating a low level and an activation voltage (H) indicating a high level. For example, the first demodulation control signal (CSa) may serve as a signal for operating the transfer gates 330A, and may have the same phase (i.e., a phase difference of) 0° as the modulated light (ML). The second demodulation control signal (CSb) may serve as a signal for operating the transfer gates 330B, and may have a phase difference of 180 degrees (It) with respect to the modulated light (ML). The third demodulation control signal (CSc) may serve as a signal for operating the transfer gates 330C, and may have a phase difference of 90 degrees (π/2) with respect to the modulated light (ML). The fourth demodulation control signal (CSd) may serve as a signal for operating the transfer gates 330D, and may have a phase difference of 270 degrees (3π/2) with respect to the modulated light (ML).

In a first period PR1, the first demodulation control signal (CSa) may have the activation voltage, and electrons generated by incident light (IL) received in the first period PR1 may be captured in the floating diffusion region FD_A by the transfer gates 330A. In this case, the electrons captured in the floating diffusion region FD_A within the first period PR1 may hereinafter be denoted by “Q(0)”.

In a second period PR2, the second demodulation control signal (CSb) may have the activation voltage, and electrons generated by incident light (IL) received in the second period PR2 may be captured in the floating diffusion region FD_B by the transfer gates 330B. In this case, the electrons captured in the floating diffusion region FD_B within the second period PR2 may hereinafter be denoted by “Q(π)”.

In a third period PR3, the third demodulation control signal (CSc) may have the activation voltage, and electrons generated by incident light (IL) received in the third period PR3 may be captured in the floating diffusion region FD_C by the transfer gates 330C. In this case, the electrons captured in the floating diffusion region FD_C within the third period PR3 may hereinafter be denoted by “Q(π/2)”.

In a fourth period PR4, the fourth demodulation control signal (CSd) may have the activation voltage, and electrons generated by incident light (IL) received in the fourth period PR4 may be captured in the floating diffusion region FD_D by the transfer gates 330D. In this case, the electrons captured in the floating diffusion region FD_D within the fourth period PR4 may hereinafter be denoted by “Q(π/2)”.

Electrons generated by the incident light (IL) having a phase difference (θ2) that is changed with the distance between the image sensing device ISD and the target object 1, may be captured in the floating diffusion region FD_A in the first period PR1, may be captured in the floating diffusion region FD_B in the second period PR2, may be captured in the floating diffusion region FD_C in the third period PR3, or may be captured in the floating diffusion region FD_D in the fourth period PR4.

Referring to FIG. 9B, a graph indicating the relationship between the phase difference (θ2) and the detected electrons Q(0), Q(π/2), Q(π), and Q(3π/2) is shown. In the graph of FIG. 9B, an Y-axis may represent a difference in the amount of charges, and a X-axis may represent a phase difference.

For convenience of description, it is assumed that electrons generated by the incident light (IL) incident upon the pixel group are captured while being divided into the first period PR1 and the second period PR2 or while being divided into the third period PR3 and the fourth period PR4, and the amount of charges captured in the first and second periods PR1 and PR2 is equal to the amount of charges captured in the third and fourth periods PR3 and PR4. That is, the total charge generated by the incident light (IL) may be defined as the sum of Q(0) and Q(π) or the sum of Q(π/2) and Q(π/2).

In addition, the absolute value of a difference between Q(0) and Q(n) will hereinafter be defined as AQ(0)=| Q(0)-Q(π)|, and the absolute value of a difference between Q(π/2) and Q(3 π/2) will hereinafter be defined as ΔQ(π/2)=|Q(π/2)−Q(π/2)|. As the first demodulation control signal (CSa) for obtaining Q(0) and the second demodulation control signal (CSb) for obtaining Q(π) have a phase difference of 90° with respect to the third demodulation control signal (CSc) for obtaining Q(π/2) and the fourth demodulation control signal (CSd) for obtaining Q(3π/2), the sum of ΔQ(0) and ΔQ(π/2) may have a constant value (i.e., the total amount of electrons).

For the sum of ΔQ(0) and ΔQ(π/2) having constant values, the change in ΔQ(0) and ΔQ(π/2) according to the phase difference (θ2) is shown in the graph of FIG. 9B. That is, as the phase difference (θ2) increases, ΔQ(0) decreases linearly in a period where the phase difference (θ2) ranges from 0 to π, and then increases linearly in a period where the phase difference (θ2) ranges from π to 2π. ΔQ(π/2) may increase linearly in a period where the phase difference (θ2) ranges from 0 to ½, may decrease linearly in a period where the phase difference (θ2) ranges from π/2 to 3π/2, and may increase linearly in a period where the phase difference (θ2) ranges from 3π/2 to 2π. Therefore, the phase difference can be calculated based on the ratio relationship between ΔQ(0) and ΔQ(π/2).

For example, the phase difference (θ2) may be calculated as represented by the following equation 2.

$$θ 2 = \{ \begin{matrix}\frac{π}{2} \cdot ( 1 + \frac{- Δ Q ( 0 )}{\vert Δ Q ( 0 ) \vert + \vert Δ Q ( \frac{π}{2} ) \vert} ) , if Δ Q ( \frac{π}{2} ) \geq 0 \\ \frac{π}{2} \cdot ( 3 + \frac{+ Δ Q ( 0 )}{\vert Δ Q ( 0 ) \vert + \vert Δ Q ( \frac{π}{2} ) \vert} ) , if Δ Q ( \frac{π}{2} ) < 0\end{matrix} \qquad [ Equation 2 ]$$

The image processor (not shown) may calculate ΔQ(0) and ΔQ(π/2) based on image data corresponding to Q(0), Q(π), Q(π/2), and Q(π/2), may calculate a phase difference by calculating the ratio between ΔQ(0) and ΔQ(π/2), and may thus obtain the distance between the image sensing device (ISD) and the target object 1.

As shown in the present embodiment, according to the 4-phase modulation method, differential values such as ΔQ(0) and ΔQ(π/2) may be used to calculate a phase difference, components caused by background noise included in each of Q(0), Q(π), Q(π/2) and Q(3π/2) can be removed (or cancelled), so that the distance to the target object can be more accurately calculated. In addition, since the image sensing device can simultaneously obtain Q(0), Q(π), Q(π/2), and Q(π/2) through only one image capture, the distance calculation speed can be improved and the distance to an object moving at a high speed can be precisely calculated with higher accuracy.

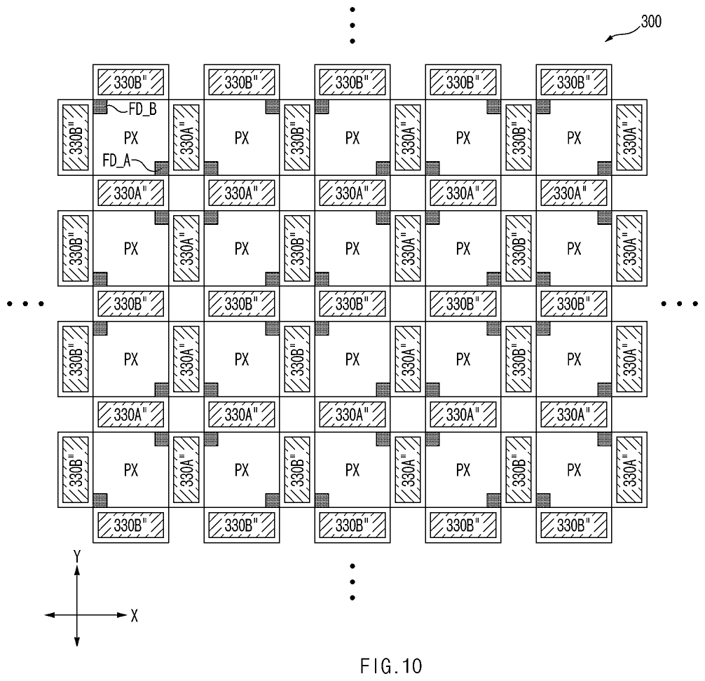

FIG. 10 is a plan view illustrating an example structure of a pixel array according to another embodiment of the disclosed technology.

Referring to FIG. 10, each unit pixel (PX) may include a photoelectric conversion element, and may be formed to be surrounded by four transfer gates (330A″, 330B″) including two transfer gates 330A″ and two transfer gates 330B.” With the transfer gates 330A″ and 330B″ surrounding the unit pixel (PX), the unit pixel (PX) can be isolated from adjacent unit pixels.

Each of the transfer gates 330A″ and 330B″ may have a rectangular horizontal cross-section and may be formed in a square pillar shape penetrating the substrate. For example, the transfer gates 330A″ and 330B″ shown in FIG. 10 may include a stacked structure in which an insulation material and a conductive material are stacked in a trench etched from the second surface (front surface) of the substrate, in the same manner as in the transfer gates 330A and 330B shown in FIGS. 3A and 3B.

The transfer gates (330A″, 330B″) may be configured such that corner regions of the transfer gates (330A″, 330B″) are connected to each other and long-axis sides of the transfer gates (330A″, 330B″) are in contact with the unit pixel (PX), so that the transfer gates (330A″, 330B″) may be formed to surround the unit pixel (PX). The transfer gates (330A″, 330B″) may be located between adjacent unit pixels (PXs) in the first and second directions. At this time, the transfer gates 330A″ and the transfer gates 330B″ may be alternately arranged in the first direction and the second direction.

The transfer gates 330A″ and 330B″ may operate based on a demodulation control signal to transfer photocharges (electrons) generated by the photoelectric conversion elements to the floating diffusion regions FD_A and FD_B. For example, for each unit pixel (PX), two transfer gates 330A″ may operate based on the first demodulation control signal to transfer photocharges generated by the photoelectric conversion elements to the floating diffusion region FD_A. The two transfer gates 330B″ may operate according to the second demodulation control signal to transfer photocharges generated by the photoelectric conversion elements to the floating diffusion region FD_B. At this time, the first and second demodulation control signals may be activated like the demodulation control signals (CSa, CSb) shown in FIG. 5.

The floating diffusion region FD_A may be located to be in contact with corner regions of the transfer gates 330A″ in each pixel region (PX), and the floating diffusion region FD_B may be located to be in contact with corner regions of the transfer gates 330B″ in each pixel region (PX). For example, the floating diffusion regions FD_A and FD_B may be located in two corner regions facing each other from among the four corner regions of each pixel region (PX). At this time, the floating diffusion region FD_A may be located in a corner region adjacent to both transfer gates 330A″, and the floating diffusion region FD_B may be located in a corner region adjacent to both transfer gates 330B″.

As is apparent from the above description, the indirect TOF image sensing device based on some implementations of the disclosed technology can more effectively transfer photocharges generated in a substrate thereof.

The embodiments of the disclosed technology may provide a variety of effects capable of being directly or indirectly recognized through the above-mentioned patent document.

Although a number of illustrative embodiments have been described, it should be understood that various modifications or enhancements of the disclosed embodiments and other embodiments can be devised based on what is described and/or illustrated in this patent document.

What is claimed is:

1. An image sensing device comprising:
a semiconductor substrate;
a plurality of unit pixels supported by the semiconductor substrate and arranged in a first direction and a second direction intersecting the first direction to form a pixel array, each unit pixel including a photoelectric conversion element configured to convert light incident to the photoelectric conversion element into photocharges, and a plurality of floating diffusion regions disposed over the photoelectric conversion element to receive and store the photocharges; and
a plurality of transfer gates supported by the semiconductor substrate and disposed between adjacent unit pixels, and configured to isolate the adjacent unit pixels from each other and to transfer the photocharges generated by the photoelectric conversion element to the plurality of floating diffusion regions.

2. The image sensing device according to claim 1, wherein:
each of the plurality of transfer gates has a horizontal cross-section of a rectangular shape, and corner regions of adjacent transfer gates arranged in a diagonal direction that is between the first direction and the second direction are in contact with each other.

3. The image sensing device according to claim 2, wherein:
the plurality of transfer gates is formed to penetrate the semiconductor substrate.

4. The image sensing device according to claim 2, wherein the plurality of transfer gates includes:
a first transfer gate formed to be in contact with a first side surface of a unit pixel;
a second transfer gate formed to be in contact with a second side surface facing or opposite to the first side surface;
a third transfer gate formed to be in contact with a third side surface that meets each of the first side surface and the second side surface, and configured to have corners that are in contact with a corner of the first transfer gate and a corner of the second transfer gate;
a fourth transfer gate formed to be in contact with a fourth side surface facing or opposite to the third side surface, and configured to have corners that are in contact with a corner of the first transfer gate and a corner of the second transfer gate.

5. The image sensing device according to claim 4, wherein:
the first transfer gate and the third transfer gate are configured to operate based on a first demodulation control signal; and
the second transfer gate and the fourth transfer gate are configured to operate based on a second demodulation control signal having a phase difference with respect to the first demodulation control signal.

6. The image sensing device according to claim 5, wherein the plurality of floating diffusion regions includes:
a first floating diffusion region disposed to contact side surfaces of the first transfer gate and the third transfer gate at a corner region where the first side surface and the third side surface meet each other; and
a second floating diffusion region disposed to contact side surfaces of the second transfer gate and the fourth transfer gate at a corner region where the second side surface and the fourth side surface meet each other.

7. The image sensing device according to claim 4, wherein:
the first to fourth transfer gates are configured to operate individually based on first to fourth demodulation control signals having different phases, respectively.

8. The image sensing device according to claim 7, wherein each of the plurality of unit pixels includes:
a first floating diffusion region disposed to be in contact with a side surface of the first transfer gate;
a second floating diffusion region disposed to be in contact with a side surface of the second transfer gate;
a third floating diffusion region disposed to be in contact with a side surface of the third transfer gate; and
a fourth floating diffusion region disposed to be in contact with a side surface of the fourth transfer gate.

9. The image sensing device according to claim 1, wherein each of the plurality of transfer gates includes:
a recess gate formed to penetrate the semiconductor substrate; and
a planar gate connected to a top surface of the recess gate and extending to be disposed over an adjacent unit pixel.

10. The image sensing device according to claim 9, wherein:
the planar gate has a cross (“+”) shape when viewed in a plane.

11. The image sensing device according to claim 1, wherein:
one of the plurality of unit pixels is surrounded by four transfer gates that are connected to each other and isolated from an adjacent unit pixel, the four transfer gates having corner regions being in contact with each other.

12. An image sensing device comprising:
a plurality of unit pixels, each unit pixel including a photoelectric conversion element configured to generate photocharges through photoelectric conversion of incident light and a plurality of floating diffusion regions configured to receive the photocharges and store the received photocharges; and
a plurality of transfer gates disposed in a substrate and surrounding each of the plurality of unit pixels and isolating each unit pixel from adjacent unit pixels, the plurality of transfer gates configured to transfer the photocharges generated by the photoelectric conversion element to the plurality of floating diffusion regions based on a plurality of demodulation control signals having different phases from one another.

13. The image sensing device according to claim 12, wherein:
each of the plurality of transfer gates and each of the plurality of unit pixels have square shapes with a same horizontal cross-sectional area.

14. The image sensing device according to claim 13, wherein:
the plurality of floating diffusion regions is located in two corner regions facing each other among four corner regions of each of the plurality of unit pixels.

15. The image sensing device according to claim 13, wherein:
the plurality of floating diffusion regions is located at side surfaces of each of the plurality of unit pixels.

16. The image sensing device according to claim 12, wherein each of the plurality of transfer gates includes:
a recess gate disposed in the substrate; and
a planar gate connected to a top surface of the recess gate and extending to be disposed over an adjacent unit pixel.

17. The image sensing device according to claim 16, wherein:
the planar gate has a cross (“+”) shape when viewed in a plane.

18. The image sensing device according to claim 12, wherein:
corner regions of the plurality of transfer gates are connected to each other and sides of the plurality of transfer gates parallel to a long-axis are in contact with the unit pixel, when viewed in a plane.

19. The image sensing device according to claim 12, wherein:
the plurality of transfer gates is formed to penetrate the substrate.
